(19) United States
(12) Patent Application Publication
(10) Pub. No.: US 2008/0283124 A1
(43) Pub. Date: Nov. 20, 2008

(54) METHOD AND APPRATUS FOR INSERTION OF AN ANTI-SIPHON GRID INTO A HOSE

(76) Inventors: Joel Hatchett, Henderson County, TN (US); Ben F. Holt, Lexington, TN (US); Jimmy Perry, Huntingdon, TN (US)

Correspondence Address: Joseph V. Tassone, Esq.;DAYCO PRODUCTS, LLC, 1 Prestige Place, Miamisburg, OH, 45342, US

(21) Appl. No.: 11/750,108

(22) Filed: May 17, 2007

(51) Int. Cl. F16L 55/10

(52) U.S. Cl. 137/15.17; 29/213.1

(57) ABSTRACT

An apparatus for installing an anti-siphon device into an automotive fuel filler comprises; a cylindrical mandrel having an inner surface and an outer surface, the outer surface of the mandrel adapted to receive a proximal end of the hose; a first grasping means configured to grasp the hose at a predetermined distance from a proximal end of the hose, and to insert the proximal end of the hose onto the outer surface of the mandrel; a first actuating means for inducing the first grasping means to grasp the hose at the predetermined distance from the proximal end of the hose, and to insert the proximal end of the hose onto the outer surface of the mandrel; a second grasping means configured to grasp and hold the proximal end of the hose on the mandrel during installation of the anti-siphon device in the hose; a second activating means for inducing the second grasping means to grasp the proximal end of the hose on the mandrel, and hold the hose thereon during installation of the anti-siphon device into the hose; an anti-siphon device insertion means having an outer surface, the anti-siphon device insertion means disposed in the mandrel, wherein the outer surface of the anti-siphon device insertion means is adjacent the inner surface of the mandrel; an anti-siphon device fixture disposed on one end of the anti-siphon device insertion means, wherein the anti-siphon device fixture is adapted to receive the anti-siphon device thereon; and a third activating means for inserting the anti-siphon device inserting means having the anti-siphon device disposed thereon, into the hose and withdrawing the anti-siphon device inserting means to the mandrel upon installing the anti-siphon device in the hose. A method is also described.

### BACKGROUND OF THE INVENTION

The present invention relates to automotive fuel systems and particularly to the installation of various devices such as an anti-siphon devices, into a fuel fill hose. More particularly, the invention relates to a method and apparatus for the installation and alignment of the device, e.g., anti-siphon device, in the hose for preventing the siphoning of fuel from an automotive fuel tank.

In recent years, the ever increasing price of liquid hydrocarbon fuel has been accompanied by a corresponding increase in liquid hydrocarbon fuel related thefts. Typically, the theft of such fuel is accomplished by siphoning the fuel from any relatively large fuel tank associated with liquid-fuel-powered machinery, e.g., automobiles, trucks, generators, etc.

Siphoning of fuel from a fuel tank generally involves placing a tubular structure through the fuel filler inlet or opening and into the fuel tank. A vacuum, such as suction pressure is applied to the opposite end of the tubular structure so that fuel from the fuel tank is drawn upwardly through the tubular structure and out of the fuel tank where the fuel is recovered in a suitable container. Siphoning generally is prevented if the hose cannot inserted into the fuel tank where the fuel is being held.

Various means have been described which prevent access to the interior of the fuel tank. Many such means include locking mechanisms. Such devices are easily opened allowing unauthorized access to the fuel filler tube and are therefore, generally ineffective. Furthermore, most of such locking devices require the use of a key which is an inconvenience to the vehicle operator. Also, such lock mechanisms are subject to malfunction during cold and inclement weather.

Other methods which prevent access to the interior of the fuel tank include the use of an anti-siphon device (ASD) having a grid structure which allows fuel to flow through a grid-like structure while preventing the insertion of a siphon tube into the fuel tank. Typically, means for installing an anti-siphoning devices includes pushing the device into the fuel tube a certain distance or simply snapping the anti-siphoning device onto the nozzle end of the fill pipe. While snapping the anti-siphoning device onto the end of the fill pipe is a convenient way of installing the anti-siphoning device into the fuel fill apparatus, the close proximity of the anti-siphoning device to the nozzle generally causes the grids of the anti-siphoning device to provide undesirable turbulence in the flow of fuel often resulting in premature shut-off of the fuel being pumped into the fuel tank. Anti-siphon devices are at least partially installed inside a fuel tank. Such devices have been described in U.S. Pat. No. 7,040,360 to Watson; U.S. Pat. No. 4,630,748 to Keller and U.S. Pat. No. 4,343,410 to Lenda. U.S. Pat. No. 3,991,792 to Kettler describes a fuel tank neck having a circumferentially annular seat area therein and a coiled spring which is inserted into the fuel tank neck such that the coiled spring expands into the annular seat thereby locking the coiled spring in the neck to provide an anti-siphon device.

Such prior art anti-siphoning devices are not only operationally complicated, but the manufacture of such devices is labor intensive and economically unattractive because of the requirement for costly compressing and welding tools. In order to overcome the undesirable shortcomings of the prior devices, it is desirable to place the anti-siphoning device as close to the tank spud as possible with out invading the fuel tank to avoid the above undesirable issues and still prevent a siphoning tube from being inserted directly into the fuel tank. This requires that the anti-siphon device be inserted into the rubber fuel fill hose. Since, for economical purposes, the outside diameter of the anti-siphon device is typically larger that the inside diameter of the rubber fuel fill hose, there exists a major problem of inserting the anti-siphon device into the rubber hose. Furthermore, the rubber fuel fill hose typically is a curved hose having one or more various degrees of bend which hinders the placing of the anti-siphon device in a square relationship with respect to the portion the fuel fill hose in which the anti-siphon device is installed. Therefore, it is desirable to provide a method for inserting an anti-siphon device having an outside diameter larger than the inside diameter of the hose into which it is being inserted, and to further simultaneously provide a method whereby the anti-siphon device is inserted through various bends in the fuel fill hose such that the anti-siphon device is aligned squarely in the hose with respect to the portion of the hose in which it is positioned.

### SUMMARY OF THE INVENTION

It is object of the invention to provide an apparatus and method for installing a mechanical device in a squarely seated position in a hose.

It is another object of the invention to prevent the siphoning of fuel from an automotive fuel tank while eliminating undesirable problems typically associated with installing such anti-siphon devices.

It is a particular object of the invention to provide an apparatus and method for installing an anti-siphon device in a rubber fuel filler hose such that the anti-siphon device is seated on an upright end of a rigid cylindrical member operatively associated with an actuator for extending the rigid cylindrical member in a linear direction. Actuation of the cylindrical member propels the cylindrical member and to a predetermined distance in the hose where the anti-siphon device is seated squarely therein.

The recent push for alternative fuels has created increasing efforts to make automobile compatible with fuels such as E85 (85% ethanol/15% gasoline). In making automobiles compatible with such fuels, a number of safety requirements associated with the fuel fill assembly and the fuel tank of such automobiles are necessary. One of these requirements is to provide protection against the siphoning of the E85 fuel from the tank. In accordance with the present invention, a method and apparatus are provided for inserting an anti-siphon device in a rubber fuel hose, wherein the anti-siphon device has an outer diameter larger that the inner diameter of rubber hose into which the anti-siphon device is inserted. The method and apparatus for installing the anti-siphon device in the rubber fuel hose provides for the anti-siphon device to be inserted through one or more various bends in the rubber hose, and for securing the anti-siphon device in the rubber hose such that the anti-siphon device is positioned in a square relationship with that portion of the hose in which the anti-siphon device is installed. That is, the longitudinal axis of the anti-siphon device, installed in accordance with the present invention, corresponds to the longitudinal axis of that portion of the rubber hose in which the anti-siphon device is installed. The anti-siphon device installed accordingly not only prevents theft of fuel from the automotive fuel tank, but it also eliminates the undesirable shortcomings of similar anti-siphon devices installed according to previously known methods.

According to a first embodiment of the invention, a method for installing the anti-siphon device into a rubber hose is described, wherein the anti-siphon device is installed in the rubber hose at a position that not only prevents siphoning of fuel from the fuel tank, but also eliminates the previous undesirable complications of fuel flow turbulence associated with known anti-siphon devices.

According to another embodiment of the invention, an apparatus is described for carrying out the method for installing the anti-siphon device in a rubber hose at a position that not only prevents siphoning of fuel from the fuel tank, but also eliminates the previous undesirable complications associated with known anti-siphon devices.

### BRIEF DESCRIPTION OF THE DRAWINGS

FIG. 1 is a perspective view of a fuel filler hose;

FIG. 2 is a side sectional, cut-a-way view of the fuel filler hose of FIG. 1 showing an anti-siphon device installed therein;

FIG. 3 is a side schematic view of the apparatus of the invention for inserting an anti-siphon device into fuel filler hose;

FIG. 4 is a side schematic view of the apparatus of FIG. 3 installing an anti-siphon device into a fuel filler hose;

FIG. 5 is another side schematic view of the apparatus of FIG. 3 installing an anti-siphon device into the fuel filler hose; and

FIG. 6 is a side schematic view of the apparatus and the hose having the anti-siphon device installed therein.

### DETAILED DESCRIPTION OF THE INVENTION

Typically, the anti-siphoning device is a relatively simple device having a cylindrical side portion and base providing a plurality of apertures such as grid members having alternating parallel and perpendicular members, or parallel ribs strategically positioned in the device and configured in such manner to allow fuel to flow unrestricted through the device while preventing any sort of siphoning tube from being inserted through the device and into the fuel tank.

The fuel filler hose in an automotive vehicle is a curved structure configured to have several bends which may be slight or acute in one or more directions. The curved configuration of the hose is necessary because of limited space available in the construction of the vehicle. While such hoses are relatively flexible, they are formed to resist appreciable deformation. Therefore, attempts to permanently insert an anti-siphon device into such hose so that the device is aligned in the hose to prevent adverse effects in filling the fuel tank has left much to be desired. The present invention provides an apparatus and a method for permanently installing an anti-siphon device into an automotive fuel filler hose such that the device is positioned in a fixed and square alignment with respect to the longitudinal axis of the hose at the point of affixation. In accordance with the invention, a method for installing the anti-siphon device employs an apparatus that effectively inserts the anti-siphon device into the hose and aligns the anti-siphon device employed in the hose. An apparatus is also described for effectively inserting and orienting the device such as an anti-siphon device, into the fuel filler hose at a predetermined distance into a fuel fill hose so that it performs at maximum efficiency without encountering the problems previously associated with installing such devices according to the prior art.

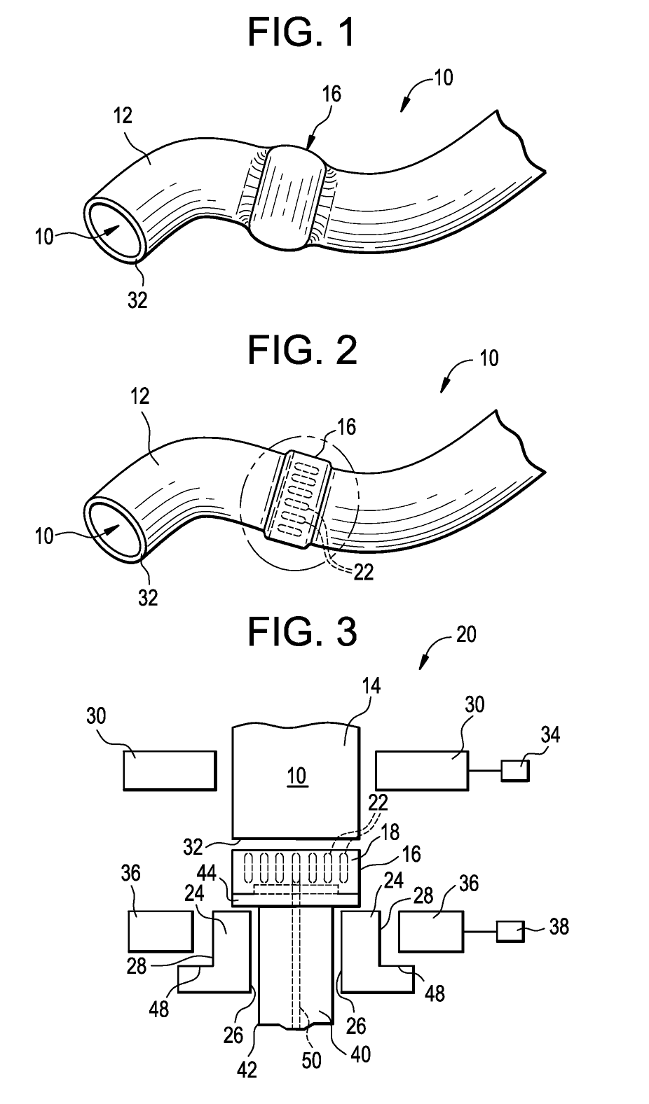

Turning to the drawings, FIG. 1 is a perspective view of a fuel filer hose 10 having an inner surface 12 and an outer surface 14, and including an enlarged area 15 which illustrates the region of the hose in where the anti-siphon device (not shown) is positioned upon installation thereof in accordance with the present invention.

FIG. 2, which is similar to FIG. 1, is a perspective view of a fuel filler hose 10 having an inner surface 12 and an outer surface 14 and, as illustrated in sectional view, an anti-siphon device 16 installed therein in accordance with the present invention. The anti-siphon device is simply a tubular member 18 formed from a rigid material and having a structure 22 such as a mesh structure within the tubular member. The mesh structure can be formed from a plurality of apertures such as grid members having alternating parallel and perpendicular members, or parallel ribs strategically positioned in the device and configured in such manner to allow fuel to flow unrestricted through the device.

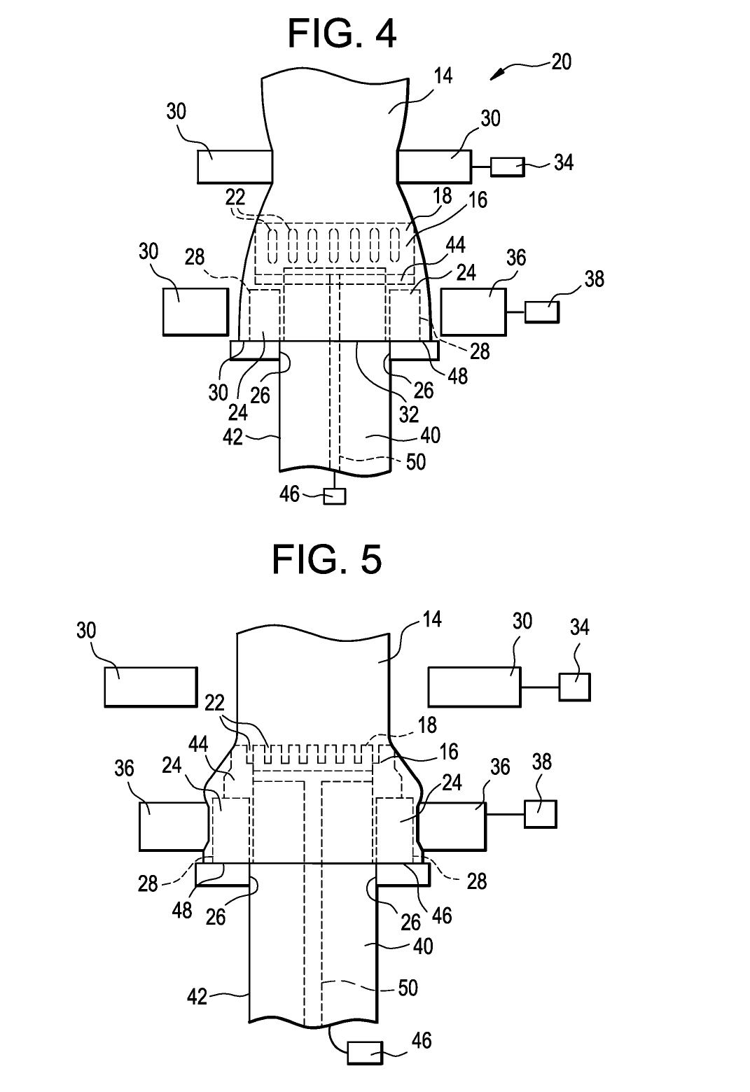

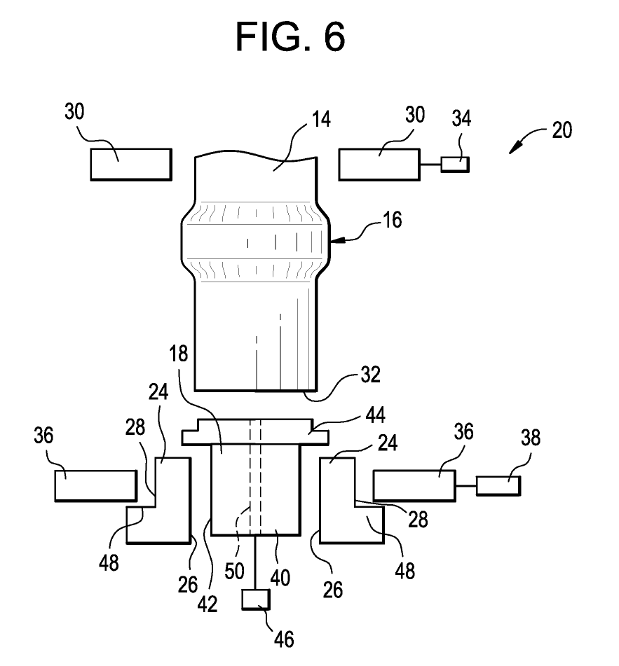

FIGS. 3 through 6 illustrate an anti-siphon device insertion apparatus and the method for inserting an anti-siphon device 16 into a fuel filler hose. More specifically, FIGS. 3-6 provide a schematic illustration of the anti-siphon device insertion apparatus 20 of the present invention. The anti-siphon device insertion apparatus 20 comprises; a cylindrical mandrel 24 having an inner surface 26 and an outer surface 28. The outer surface 28 of the mandrel 24 is adapted to receive a proximal end of the hose 10. The mandrel further includes a perpendicular shoulder 48 extending circumferentially around the mandrel 24 to act as a stop for the proximal end 32 of the hose when the hose is inserted onto the mandrel 24.

A first grasping means 30 is configured to grasp the hose 10 at a predetermined distance from a proximal end 32 of the hose 10, and to insert the proximal end 32 of the hose 10 onto the outer surface of the mandrel 24. The first grasping means 30 is actuated by a first actuating means 34 to induce the first grasping means 30 to grasp the hose 10 at the predetermined distance from the proximal end 32 of the hose 10, and to insert the proximal end 32 of the hose 10 onto the outer surface 28 of the mandrel 24. Since the anti-siphon device 16 typically has an outer diameter that is larger than the inner diameter of the hose 10, a lead-in means, hose expansion means, or other hose end configuration such as a flared end may be necessary in order to allow the proximal end 32 of the hose 10 to be pushed over the anti-siphon device 16 and on to the mandrel 24 where the proximal end 32 of the hose 10 abuts the perpendicular shoulder 48 of mandrel 24. As illustrated in FIG. 3, the hose may include a flared terminal portion 52 of hose end 32 in order to facilitate insertion of the hose 10 over the mandrel 24. A second grasping means 36 configured to grasp and hold the proximal end 32 of the hose 10, is actuated by a second actuating means 36 to grasp the hose 10 between the proximal end 32 of the hose 10 and the anti-siphon device 16 on the mandrel 24. The locations of the mandrel 24 and the second grasping means 36 are critical in that the second grasping means 36 must grasp and hold the hose 10 vertically between the anti-siphon device 16 and the proximal end 32 of the hose 10 during installation of the anti-siphon device 16 in the hose 10.

Upon grasping the hose 10 by the second grasping means 36, the first actuating means 34 is deactivated, releasing the first grasping means 30 from the hose 10 to prevent destruction of the anti-siphon device 16 as the anti-siphon device 16 is inserted into the hose 10 An anti-siphon device insertion means 40, includes an anti-siphon device fixture 44 disposed on one end of the anti-siphon device insertion means 40, wherein the anti-siphon device fixture 44 is adapted to receive the anti-siphon device 16 thereon. The anti-siphon device insertion means 40, typically, in the form of a rod having an outer surface 42 is disposed in the mandrel 24 adjacent the inner surface 26 of the mandrel 24. The anti-siphon device 16 also includes an opening 50 in the center of the rod-like structure for supplying a lubricant to the inner surface of the hose which allows the anti-siphon device insertion means 40 to be more efficiently utilized. Typically, lubricant is stored in a cavity member positioned at a vertically higher location than that of the cylinder wherein gravity is then used to feed the lubricant up through the opening in center of the insertion member to provide lubrication to the inner surface of the tube. The amount of lubricant dispensed to the center of the insertion member is controlled by a valve. While this method has been found to be satisfactory in providing the lubricant to the apparatus, other method of supplying the lubricant to the apparatus may be equally effective. The anti-siphon device insertion means 40, including the anti-siphon device 16, is actuated in an upward direction by a third actuation means 46 to insert the anti-siphon device 16 at the proper location in the hose 10. The actuating means 40 for driving the anti-siphon device may be any of the actuating means known in the art capable of driving a rod along a cylindrical wall. Such actuating means may be motivated by electrical, mechanical, hydraulic or pneumatic means. In a particularly effective aspect of the invention, the third activating means comprises a cylinder housing a pneumatic driving rod for actuating the insertion means into the hose. A pair of ports are located at opposing ends of the cylinder provide appropriate passage ways for supplying air pressure to propel the pneumatic driving rod. After insertion of the anti-siphon device 16, in the hose 10, the anti-siphon device insertion means 40 retreats in a downward direction to its original position where it is ready to insert another anti-siphon device into another hose. While the anti-siphon device insertion apparatus 20 is illustrated in FIGS. 3-6 in a first aspect of the invention as being oriented in vertical configuration in which the anti-siphon device 16 is inserted upwardly into the hose 10, it is also within the concept of the present invention to insert the anti-siphon device insertion apparatus 20 into hose 10 in a second aspect of the invention, wherein the anti-siphon device insertion apparatus 20 is oriented 1800 from that of the first aspect. In the second aspect of the invention, the anti-siphon device 16 is inserted downwardly into the hose 10 allowing the hose to hang free and unrestricted as the anti-siphon device 16 is inserted therein.

In one embodiment of the invention, the anti-siphon device is inserted into the hose in a single constant motion using an anti-siphon device insertion apparatus.

In another embodiment of the invention, the anti-siphon device is inserted into the hose using a multi-step insertion, which allows for greater flexibility and possibly the insertion of the anti-siphon device through configurations that might not otherwise be feasible. The anti-siphon device could be inserted to a predetermined point with a first “gripper” means activated. A second “gripper” means could then be activated as the first “gripper” means is released. The anti-siphon device would then be inserted to a location associated with the second “gripper” means. This process could be repeated as often as needed to insure that the device is properly located with respect to location and configuration within the hose. The multi-step insertion could be accomplished by employing any of the art recognized means. For example, the anti-siphon device may be inserted into the hose using a caterpillar-type cylinder design or through the use of a servomechanism.

Typically, the grasping means is a pair of semi-circular members having an inner dimension and configuration corresponding to the outer surface of the hose. Each of the semi-circular members are actuated by an actuating means to cause the grasping members to grasp or release the hose, depending on the action required. The actuating means is activated by mechanical, electrical, pneumatic or hydraulic devices, or by a combination of such devices.

The mandrel employed in the present invention can be formed from any suitable rigid material exhibiting the desired characteristics that will allow the mandrel to perform its intended task. Typically, the mandrel is formed from a metal material such as stainless steel, aluminum, or other corrosion-resistant metals or alloys, a ceramic material, or a polymeric materials, e.g., reinforced nylon, polyethylene, etc. Preferably, the mandrel is formed from stainless steel.

The first and second grasping means employed to grasp and hold the hose during the insertion of the anti-siphon device into the hose, can be of any configuration which can effectively grasp and hold the hose. Typically, each of the first and second grasping means comprise a pair of opposed semi-circular members sized corresponding to the outer surface of the hose and configured such that the inner surface of each opposed semi-circular member fit snuggly against the outer surface of the hose to provide grasping and holding force thereto. In certain aspects of the invention, it may be desirable to provide the inner surface of the semi-circular arms with a rough surface to increase the surface friction and provide enhanced holding force.

The use of a lubricant in carrying out the invention is highly preferred because of the difficulty in inserting a anti-siphon device which has an outer diameter significantly larger than the inner diameter of the hose into which the anti-siphon device is being inserted. Lubricants useful in the present invention are those that provide sufficient lubrication during the insertion step. Preferable, the lubricant is any of the environmentally safe lubricating materials useful in the rubber industry as a rubber-lubricant.

While the above invention has been described as an apparatus and method for inserting an anti-siphon device into a fuel hose, the apparatus and method of the present invention may be employed to insert other conventional devices such as flame arresters, flapper valves, orifices, etc. into flexible hoses; and the scope of the present invention is intended to employ the apparatus and method described herein to insert such other devices as well as an anti-siphon device into a hose.

What is claimed is:

1. An apparatus for installing a mechanical device selected from the group: consisting of an anti-siphon device, a flame arrester, flapper valve, and an orifice into an automotive fuel filler hose, said apparatus comprising:
a cylindrical mandrel having an inner surface and an outer surface, said outer surface of said mandrel adapted to receive a proximal end of said hose;
a first grasping means configured to grasp said hose at a predetermined distance from a proximal end of said hose, and to insert said proximal end of said hose onto said outer surface of said mandrel;
a first actuating means for inducing said first grasping means to grasp said hose at said predetermined distance from said proximal end of said hose, and to insert said proximal end of said hose onto said outer surface of said mandrel;
a second grasping means configured to grasp and hold said proximal end of said hose on said mandrel during installation of said mechanical device in said hose;
a second activating means for inducing said second grasping means to grasp said proximal end of said hose on said mandrel, and hold said hose thereon during installation of said mechanical device into said hose;
a mechanical device insertion means having an outer surface, said mechanical device insertion means disposed in said mandrel, wherein said outer surface of said mechanical device insertion means is adjacent said inner surface of said mandrel;
a mechanical device fixture disposed on one end of said mechanical device insertion means, wherein said mechanical device fixture is adapted to receive said mechanical device thereon;
a third activating means for inserting said anti-siphon device inserting means having said mechanical device disposed thereon, into said hose and withdrawing said mechanical device inserting means to said mandrel upon installing said mechanical device in said hose.

2. The apparatus of claim 1 wherein said mechanical device is an anti-siphon device.

3. The apparatus of claim 1 wherein said cylindrical mandrel comprises a shoulder portion extending radially outwardly from said outer surface of said mandrel to limit the distance said hose can be inserted onto said mandrel.

4. The apparatus of claim 3 wherein said shoulder portion extends circumferentially around said cylindrical mandrel.

5. The apparatus of claim 1 wherein said mandrel is formed from a rigid material selected from the group consisting of metal, ceramic and polymer.

6. The apparatus of claim 5 wherein said rigid material is stainless steel.

7. The apparatus of claim 1 wherein each of said first and said second clamping means comprises a pair of opposed semi-circular members sized to correspond to the outer surface of said hose and configured to grasp and hold said hose.

8. The apparatus of claim 1 wherein each of said first actuating means, said second actuating means, and said third actuating means is a mechanical, electrical, pneumatic or hydraulic device, or a combination of such devices.

9. The apparatus of claim 1 wherein said mechanical device insertion means comprises lubricating means, wherein said lubrication means is effective for providing lubricant to said hose during insertion of said mechanical device therein.

10. The apparatus of claim 1 wherein said mechanical device insertion means is a flexible rod.

11. The apparatus of claim 1 wherein said mechanical device insertion means is a caterpillar-type rod.

12. A method of inserting a mechanical device selected from the group consisting of an anti-siphon device, a flame arrester, flapper valve, and orifice into an automotive fuel filler hose, said method comprising:
providing a cylindrical mandrel having an inner surface and an outer surface, said outer surface of said mandrel adapted to receive a proximal end of said hose;
providing a first grasping means configured to grasp said hose at a predetermined distance from said proximal end of said hose;
actuating said first grasping means, inducing said first grasping means to grasp said hose and insert said proximal end of said hose onto said outer surface of said mandrel to a predetermined distance;
providing a second grasping means configured to grasp and hold said hose on said mandrel;
actuating said second activating means and inducing said second grasping means to grasp and hold said proximal end of said hose on said mandrel during installation of said mechanical device into said hose;
actuating said first grasping means, inducing said first grasping means to release said hose;
providing an anti-siphon device insertion means having an outer surface, said anti-siphon device insertion means disposed in said mandrel, wherein said outer surface of said mechanical device insertion means is adjacent said inner surface of said mandrel;
providing a mechanical device fixture disposed on one end of said mechanical device insertion means, wherein said mechanical device fixture is adapted to receive said mechanical device thereon;
providing a third actuating means configured to insert said mechanical device inserting means and said mechanical device into said hose;
actuating said third actuating means and inducing said third actuation inserting means having said mechanical device disposed thereon, into said hose;
withdrawing said mechanical device inserting means to said mandrel upon installing said anti-siphon device in said hose;
actuating said second activating means and inducing said second grasping means to release said hose; and
recovering said hose having said mechanical device installed therein.

13. The method of claim 12 wherein said mechanical device is an anti-siphon device.

14. The method of claim 12 wherein each of said first and said second clamping means comprises a pair of opposed semi-circular members sized to correspond to the outer surface of said hose and configured to grasp and hold said hose.

15. The method of claim 12 wherein each of said first actuating means, said second actuating means, and said third actuating means is a mechanical, electrical, pneumatic or hydraulic device, or a combination of such devices.

16. The method of claim 12 wherein said mechanical device insertion means is a flexible rod.

17. The method of claim 12 wherein said mechanical device insertion means is a caterpillar type rod.

18. The method of claim 12 wherein said mechanical device is inserted in a single constant motion.

19. The method of claim 12 wherein said mechanical device is installed in said hose in multi-step motion.

20. The method of claim 12 wherein said mechanical device is installed in said hose in the presence of a rubber-lubricant.
